(19) United States
(12) Patent Application Publication
(10) Pub. No.: US 2005/0141155 A1
(43) Pub. Date: Jun. 30, 2005

(54) Voltage generator circuit

(75) Inventors: Hidenori Kidani, Osaka (JP); Hideki Mine, Osaka (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toshiba Matsushita Display Technology Co., Ltd., Tokyo (JP)

(21) Appl. No.: 10/504,597

(22) PCT Filed: Nov. 10, 2003
(86) PCT No.: PCT/JP03/14242

(30) Foreign Application Priority Data
Nov. 21, 2002 (JP) 2002-338333

(51) Int. Cl. H02H 3/20

(52) U.S. Cl. 361/90

(57) ABSTRACT

A CPU has to spend a long time of the order of several tens to several hundreds ms, which is required for wait processing when all the voltages are generated, on wait processing and thus the CPU cannot perform other operations during the wait processing, resulting in low working efficiency on the startup of the CPU in a liquid crystal display device.

A liquid crystal driving voltage generating circuit 540 includes a voltage generating/outputting circuit 543 which generates two or more kinds of voltages, each having a predetermined voltage value, and outputs the generated voltages, a counter circuit 541 of performing counting according to a control signal inputted with a predetermined period from the outside, and a voltage generation timing managing circuit 542 of managing the timing of generating voltage according to the performed counting (count control).

### TECHNICAL FIELD

The present invention relates to a voltage generating circuit available for, for example, a liquid crystal display device.

### BACKGROUND ART

Liquid crystal display devices are widely used for various displays of personal computers and personal digital assistants because the liquid crystal display devices are thin, lightweight, and low-power devices.

Referring to FIG. 6 which is a structural diagram showing a conventional liquid crystal display device, the configuration of the conventional liquid crystal display device will be described below (e.g., Japanese Patent Laid-Open No. 9-243996 and Japanese Patent Laid-Open No. 11-202840).

The entire disclosure of Japanese Patent Laid-Open No. 9-243996 and Japanese Patent Laid-Open No. 11-202840 are incorporated herein by reference in its entirety.

The conventional liquid crystal display device comprises a liquid crystal display panel (matrix liquid crystal display panel) 670 having a source driver 660 and a gate driver 650, a liquid crystal driving voltage generating circuit 640 of generating voltage for liquid crystal display, and a controller circuit 630 having an image signal processing circuit 631 and a control signal processing circuit 632. In FIG. 6, the so-called main body of the liquid crystal display device is indicated by a broken line surrounding the above means.

The configuration of the conventional liquid crystal display device will be described in detail.

An input power supply 610 is means of feeding supply voltage which drives a CPU 620, the controller circuit 630, and the liquid crystal driving voltage generating circuit 640.

The CPU (central processing unit) 620 is means of managing wait time (wait processing), which will be discussed later, in the liquid crystal driving voltage generating circuit 640. Further, the CPU 620 is means of sending a command for each signal processing to the controller circuit 630.

The image signal processing circuit 631 is means of supplying display data to the liquid crystal display panel 670.

The control signal processing circuit 632 is means of controlling the liquid crystal driving voltage generating circuit 640, the gate driver 650, and the source driver 660.

The liquid crystal driving voltage generating circuit 640 is means of generating on/off voltage of a switching device (not shown) such as a thin-film transistor (TFT), video signal voltage, and voltage such as counter voltage required for driving the liquid crystal display panel 670.

The gate driver 650 is means of applying scan selecting voltage, which has been generated in the liquid crystal driving voltage generating circuit 640, to a gate line according to a synchronizing signal sent from the controller circuit 630.

The source driver 660 is means of applying a video signal, which has been sent from the controller circuit 630, to a source line according to pixel data.

The liquid crystal display panel 670 is means of providing liquid crystal display when the video signal corresponding to the pixel data to each pixel is inputted.

The operations on the startup of the conventional liquid crystal display device will be described below.

Supply voltage is inputted from the input voltage source 610 to the CPU 620, the controller circuit 630, and the liquid crystal driving voltage generating circuit 640 to enable the driving of the means.

The CPU 620 having started its driving sends a signal processing command of liquid crystal display to the controller circuit 630.

The controller circuit 630 having received the command of liquid crystal display sends a control signal to the liquid crystal driving voltage generating circuit 640, the gate driver 650, and the source driver 660.

In this way, a plurality of liquid crystal driving voltages required for driving the means, which are generated in the liquid crystal driving voltage generating circuit 640, are sent to the gate driver 650, the source driver 660, and the liquid crystal display panel 670, respectively.

The gate driver 650 turns on/off a switching device by using scanning signals applied sequentially through a plurality of gate lines, and the source driver 660 provides liquid crystal display based on liquid crystal driving by using a sent video signal and a potential difference of counter voltages in the liquid crystal display panel 670.

In this way, in order to drive the liquid crystal display device, various necessary voltages are generated in the liquid crystal driving voltage generating circuit 640.

Incidentally, when these voltages are sequentially generated thus, if the subsequent voltage is generated and causes reversed potentials before generated voltage is stabilized, a latch-up phenomenon may occur in the liquid crystal driving voltage generating circuit, resulting in improper voltage generation and abnormal liquid crystal display. Further, flow-through current may break the circuit.

Thus, on startup, wait time is provided from the stabilization of a generated potential to the start of the generation of the subsequent voltage.

The management of wait time will be specifically described below mainly with reference to FIG. 3 which is an explanatory drawing for explaining a voltage rising sequence from when voltage generation is started on startup to when the subsequent image display is started in the conventional liquid crystal display device, and FIG. 4 which is an explanatory drawing for explaining the timing of generating liquid crystal driving voltages V31 to V35 by the conventional liquid crystal driving voltage generating circuit 640 on startup.

FIGS. 3 and 4 show the case of V31=V32>V33>V34=V35.

In the conventional liquid crystal display device, the CPU 620 manages wait time provided from the stabilization of a potential to the start of the generation of the subsequent voltage.

The voltage value settings of V31 and V32 are transferred from the controller circuit 630 to the liquid crystal driving voltage generating circuit 640 and the voltages start rising. At the same time, wait processing W1 is started in the CPU 620.

The CPU 620 performs monitoring all the time until the potentials of V31 and V32 are stabilized.

The voltage V33 starts to rise after the potentials of V31 and V32 are stabilized, and then the CPU 620 completes the wait processing W1 and performs wait processing W2 for V33.

After the potential of V33 is stabilized, the CPU 620 starts wait processing W3 concurrently with the rise of the voltages V34 and V35.

All the wait processing of the CPU 620 is completed after the potentials of V34 and V35 are stabilized. The image display processing setting is transferred from the CPU 620 via the controller circuit 630, and image display processing is started.

As shown in FIG. 8 which is a detailed explanatory drawing for explaining the timing of generating liquid crystal driving voltage by the conventional liquid crystal driving voltage generating circuit 640 on the startup, the specific example of V31=V32 includes AVDD_CP (AVDD, VCOM, VGE operational amplifier power supply), VGG_CP (VGG operational amplifier power supply), and VEE_CP (VEE operational amplifier power supply), the specific example of V33 includes AVDD (analog supply voltage for a source driver), VGG (on voltage for a switching device), VEE (off voltage for a switching device), and the specific example of V34=V35 includes VCOM (common potential) and VGE (gate compensating supply voltage).

However, the inventor found that the CPU 620 has to spend a long time of the order of several tens to several hundreds ms, which is required for wait processing when all the voltages are generated, on wait processing and thus the CPU 620 cannot perform other operations during the wait processing.

Further, the inventor found that the CPU 620 consequently has quite low operation efficiency on the startup of the conventional liquid crystal display device.

### DISCLOSURE OF THE INVENTION

In view of the conventional problems, an object of the present invention is to provide a voltage generating circuit which can improve, for example, the operation efficiency of a CPU on the startup of a liquid crystal display device.

A first invention of the present invention is a voltage generating circuit, comprising:
voltage generating/outputting means which generates two or more kinds of voltages, each having a predetermined voltage value, and outputs the generated voltages,
counter means of performing counting according to a control signal inputted with a predetermined period from an outside, and
voltage generation timing managing means of managing timing of generating the voltages according to the performed counting.

A second invention of the present invention is the voltage generating circuit according to the first invention, wherein the two or more kinds of voltages are driving voltages of driving a plurality of circuits in a display device, the driving voltages being determined for the respective circuits.

A third invention of the present invention is the voltage generating circuit according to the second invention of the present invention, wherein the control signal inputted from the outside is a control signal which is inputted from a controller circuit to control the plurality of circuits in the display device.

A fourth invention of the present invention is the voltage generating circuit according to the second invention of the present invention, wherein the predetermined period is a frame period used for display provided in the display device.

A fifth invention of the present invention is a display device, comprising:
the voltage generating circuit according to the first invention of the present invention,
a display panel having a plurality of pixels arranged so as to correspond to intersections of source lines in two or more columns and gate lines in two or more rows,
a source driver of driving the source lines in the two or more columns by using source line driving voltage required for driving the source lines in the two or more columns, and
a gate driver of driving the gate lines in the two or more columns by using gate line driving voltage required for driving the gate lines in the two or more columns.

A sixth invention of the present invention is a method of generating voltage, comprising:
a voltage generating/outputting step of generating two or more kinds of voltages, each having a predetermined voltage value, and outputting the generated voltages,
a counting step of performing counting according to a control signal inputted with a predetermined period from the outside, and
a voltage generation timing managing step of managing timing of generating the voltages according to the performed counting.

A seventh invention of the present invention is a program of causing a computer to perform the counting step of performing counting according to a control signal inputted with a predetermined period from the outside, and a voltage generation timing managing step of managing timing of generating the voltages according to the performed counting, in accordance with the method of generating voltage according to the sixth invention of the present invention.

An eighth invention of the present invention is a recording medium bearing the program of the seventh invention of the present invention and is a recording medium which can be processed by the computer.

### BRIEF DESCRIPTION OF THE DRAWINGS

FIG. 1 is an explanatory drawing for explaining a voltage rising sequence from when voltage generation is started on startup to when image display processing is started in a liquid crystal display device according to Embodiment 1 of the present invention;

FIG. 2 is an explanatory drawing for explaining the timing of generating liquid crystal driving voltages V11 to V15 on startup by a liquid crystal driving voltage generating circuit 540 according to Embodiment 1 of the present invention;

FIG. 3 is an explanatory drawing for explaining a voltage rising sequence from when voltage generation is started on startup to when image display processing is started in a conventional liquid crystal display device;

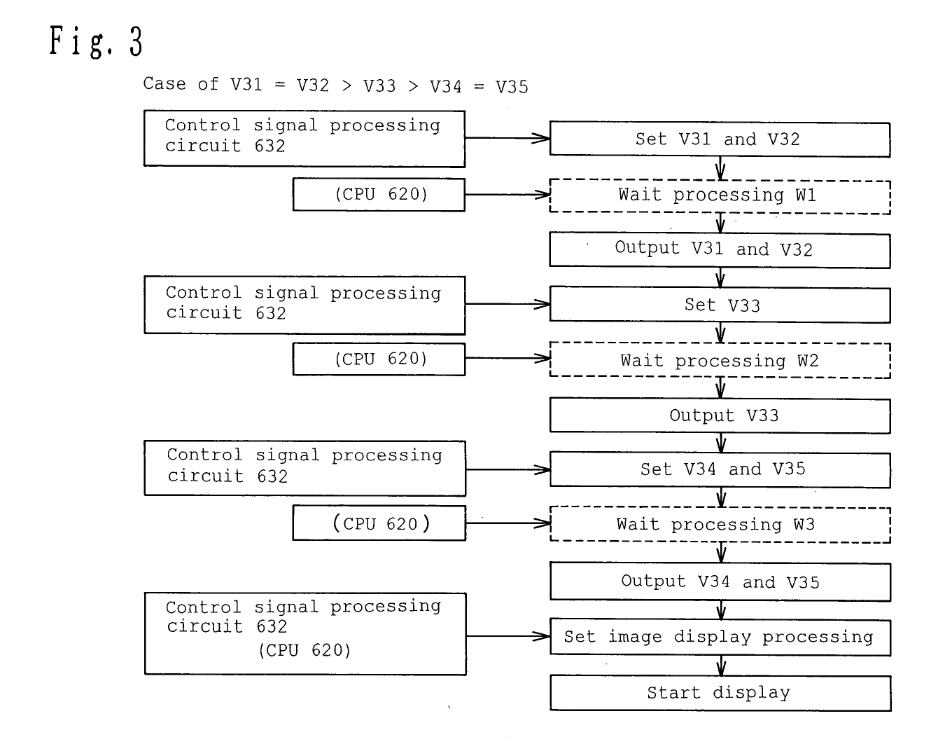

FIG. 4 is an explanatory drawing for explaining the timing of generating liquid crystal driving voltages V31 to V35 on startup by a conventional liquid crystal driving voltage generating circuit 640;

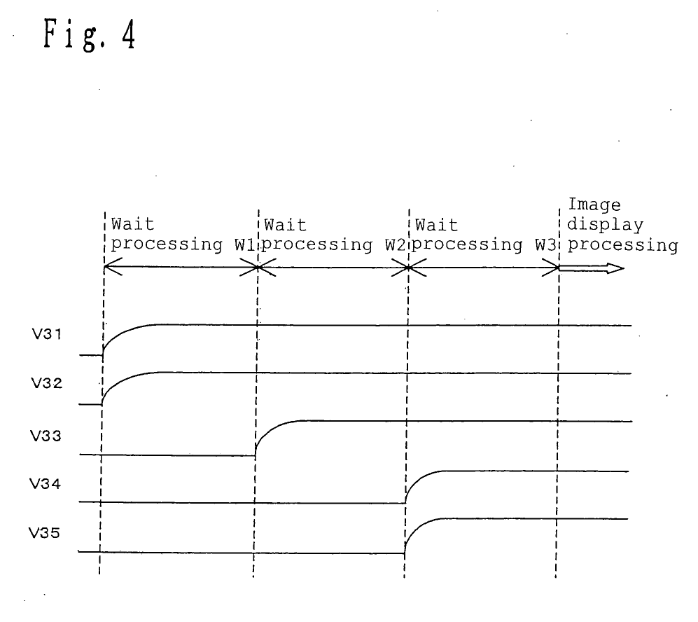

FIG. 5 is a structural diagram showing the liquid crystal display device according to Embodiment 1 of the present invention;

FIG. 6 is a structural diagram showing a conventional liquid crystal display device;

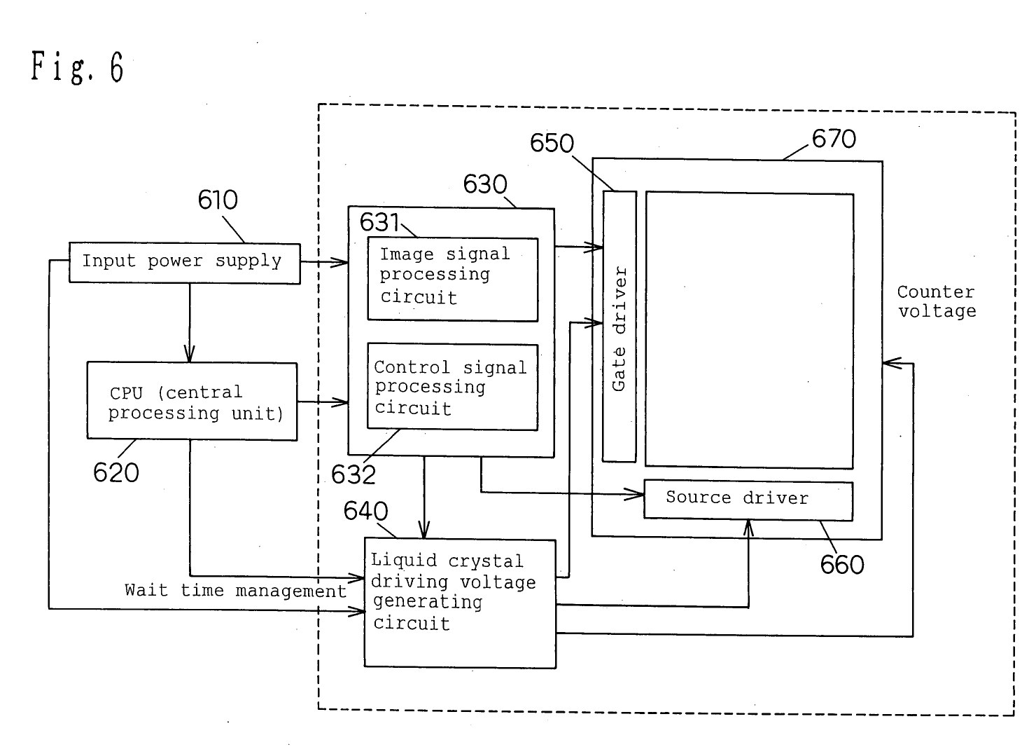

FIG. 7 is a detailed explanatory drawing for explaining the timing of generating liquid crystal driving voltages on startup by the liquid crystal driving voltage generating circuit 540 according to Embodiment the present invention; and

FIG. 8 is a detailed explanatory drawing for explaining the timing of generating liquid crystal driving voltages on startup by the conventional liquid crystal driving voltage generating circuit 640.

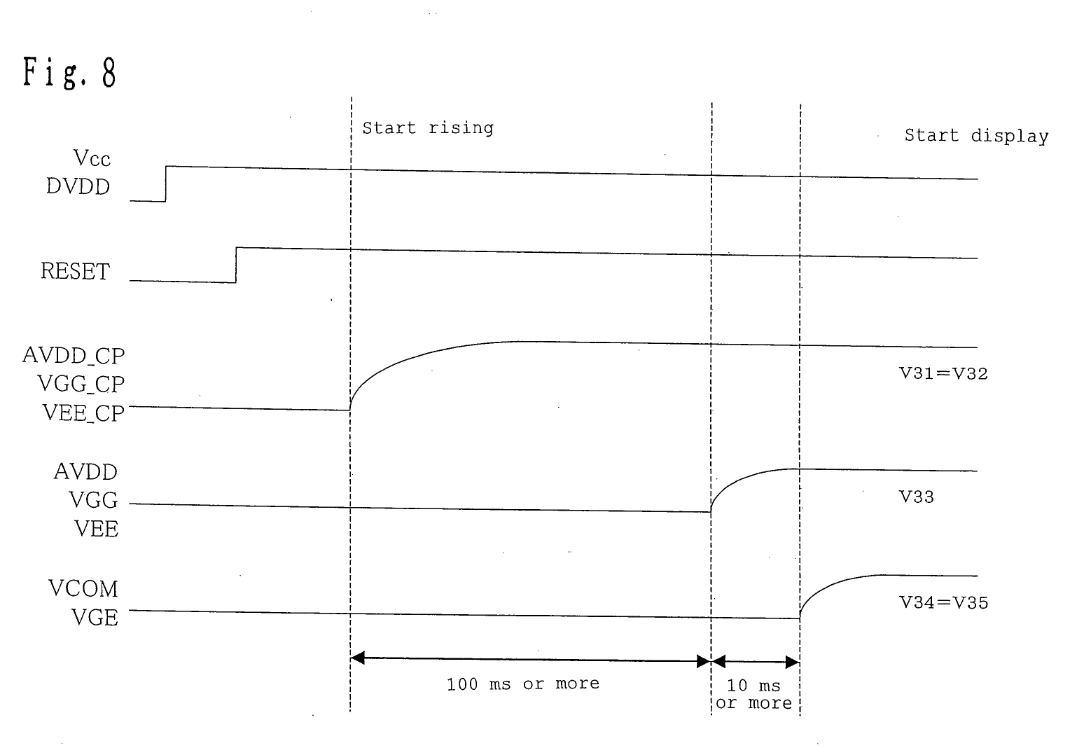

### DESCRIPTION OF SYMBOLS

510 Input power supply
520 CPU (central processing unit)
530 Controller circuit
531 Image signal processing circuit
532 Control signal processing circuit
540 Liquid crystal driving voltage generating circuit
541 Counter circuit
542 Voltage generation timing managing circuit
543 Voltage generating/outputting circuit
550 Gate driver
560 Source driver
570 Liquid crystal display panel
610 Input power supply
620 CPU (central processing unit)
630 Controller circuit
631 Image signal processing circuit
632 Control signal processing circuit
640 Liquid crystal driving voltage generating circuit
650 Gate driver
660 Source driver
670 Liquid crystal display panel

### BEST MODE FOR CARRYING OUT THE INVENTION

An embodiment of the present invention will be described below in accordance with the accompanying drawings.

### Embodiment 1

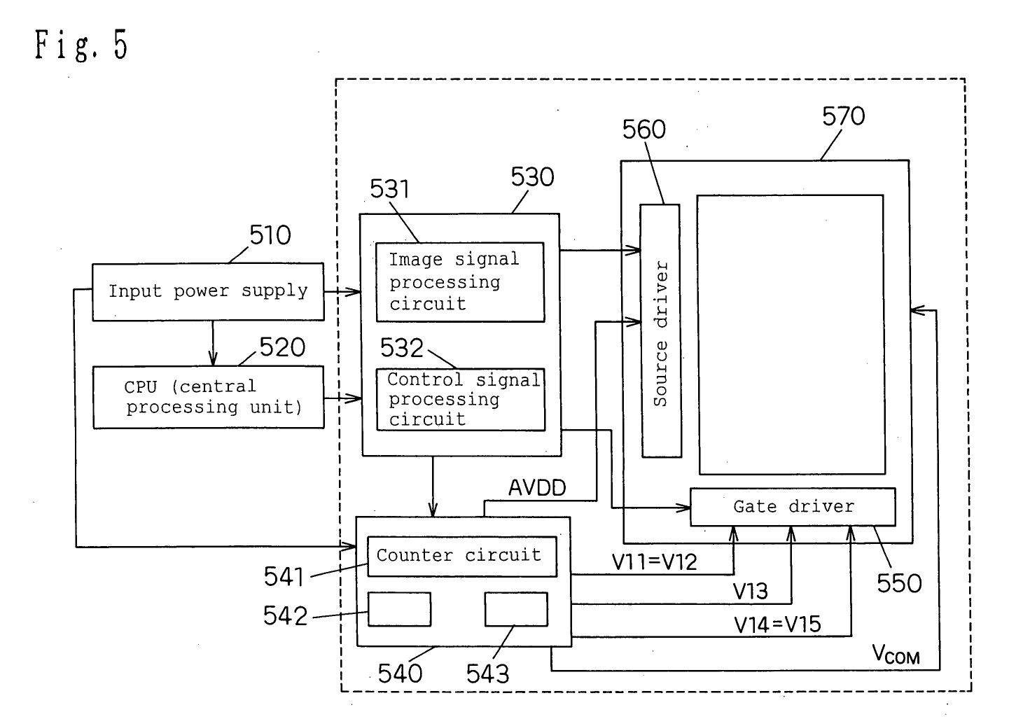

First, mainly referring to FIG. 5 which is a structural diagram showing a liquid crystal display device according to Embodiment 1 of the present invention, the configuration of the liquid crystal display device of the present embodiment will be discussed below.

The liquid crystal display device of the present embodiment comprises a liquid crystal display panel (matrix liquid crystal display panel) 570 having a source driver 560 and a gate driver 550, a liquid crystal driving voltage generating circuit (DC-DC) 540 which generates voltage required for providing liquid crystal display, and a controller circuit 530 having an image signal processing circuit 531 and a control signal processing circuit 532. In FIG. 5, the so-called main body of the liquid crystal display device is indicated by a broken line surrounding the above means.

The liquid crystal display device of the present embodiment is characterized in that a control signal supplied with a predetermined period from the control signal processing circuit 532 to the liquid crystal driving voltage generating circuit 540 is counted by a counter circuit 541 provided in the liquid crystal driving voltage generating circuit 540, and liquid crystal driving voltage is generated and outputted according to a count set for each liquid crystal driving voltage.

In the conventional liquid crystal display device, the CPU 620 always monitors wait processing until the potential of liquid crystal driving voltage is stabilized. In the liquid crystal display device of the present embodiment, wait processing is artificially realized by using the counter circuit 541. Therefore, the CPU 520 does not have to monitor wait processing and voltage all the time, and other processing including the starting of image display on the liquid crystal display panel 570 can be performed concurrently with voltage generation. Thus, the working efficiency of the CPU 520 on the startup of the liquid crystal display device of the present embodiment is greatly increased as compared with the conventional art.

The following will describe the detail of the configuration of the liquid crystal display device according to the present embodiment.

Like the input power supply 610, an input power supply 510 is means of feeding supply voltage required for driving the CPU 520, the controller circuit 530, and the liquid crystal driving voltage generating circuit 540.

The CPU (central processing unit) 520 is means of sending a command of each signal processing to the controller circuit 530.

Like the image signal processing circuit 631, the image signal processing circuit 531 is means of supplying display data to the liquid crystal display panel 570.

The control signal processing circuit 532 is means of supplying a control signal of a predetermined period to the liquid crystal driving voltage generating circuit 540. Further, the control signal processing circuit 532 is means of controlling the liquid crystal driving voltage generating circuit 540, the gate driver 550, and the source driver 560.

The liquid crystal driving voltage generating circuit 540 is means which has the counter circuit 541 of counting a control signal supplied with a predetermined period from the control signal processing circuit 532, a voltage generating/outputting circuit 543 of generating and outputting liquid crystal driving voltage according to a count set for each liquid crystal driving voltage, and a voltage generation timing managing circuit 542 of managing the timing of generating the liquid crystal driving voltage according to the set count. Since the stability control for the generation and output of driving voltage requires several tens to several hundreds ms, in view of the minimization of the circuit configuration of the counter circuit 541, a control signal of a frame period, which is necessary in the liquid crystal display device, is used also as a control signal having the predetermined period. Moreover, the liquid crystal driving voltage generating circuit 540 is means of generating voltages such as on/off voltage of a switching device (not shown), video signal voltage, and counter voltage that are required for driving the liquid crystal display panel 570.

Like the gate driver 650, the gate driver 550 is means of applying scan selecting voltage generated by the liquid crystal driving voltage generating circuit 540 to a gate line according to a synchronizing signal sent from the controller circuit 530.

Like the source driver 660, the source driver 560 is means of applying a video signal sent from the controller circuit 530 to a source line according to pixel data.

Like the liquid crystal display panel 670, the liquid crystal display panel 570 is means of providing liquid crystal display when the video signal corresponding to the pixel data to each pixel is inputted.

Additionally, the voltage generating/outputting circuit 543 corresponds to the voltage generating/outputting means of the present invention, the counter circuit 541 corresponds to the counter means of the present invention, the voltage generation timing managing circuit 542 corresponds to the voltage generating output means of the present invention, and the liquid crystal driving voltage generating circuit 540 corresponds to the voltage generating circuit of the present invention. Moreover, the liquid crystal display device of the present embodiment corresponds to the display device of the present invention. Further, the means including gate driver 550, the source driver 560, and the liquid crystal display panel 570 corresponds to a plurality of circuits of the present invention.

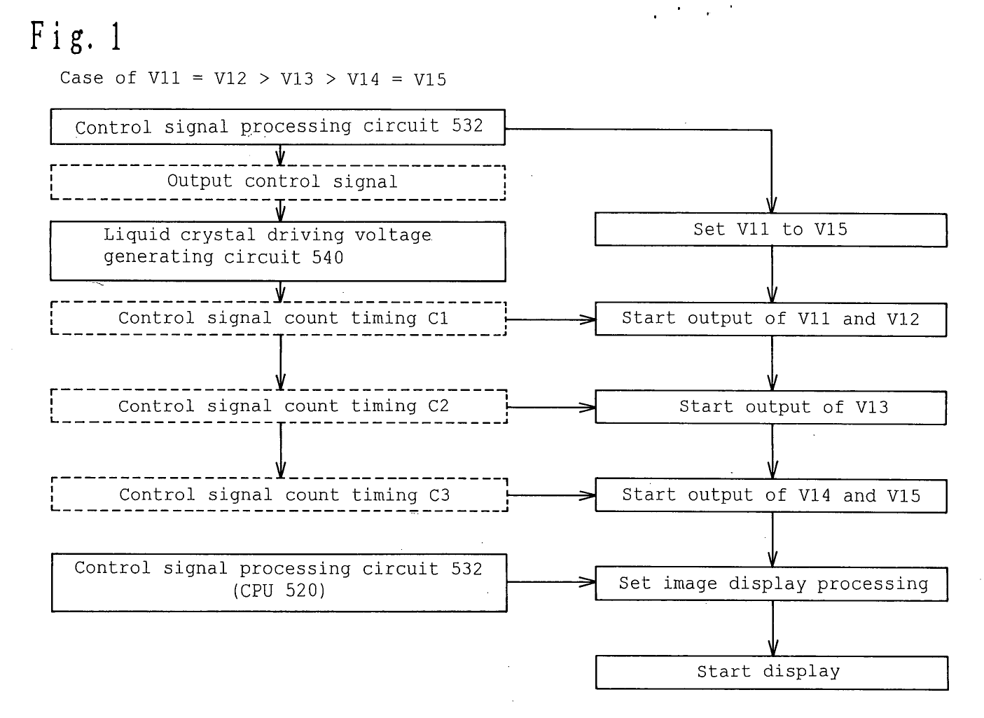

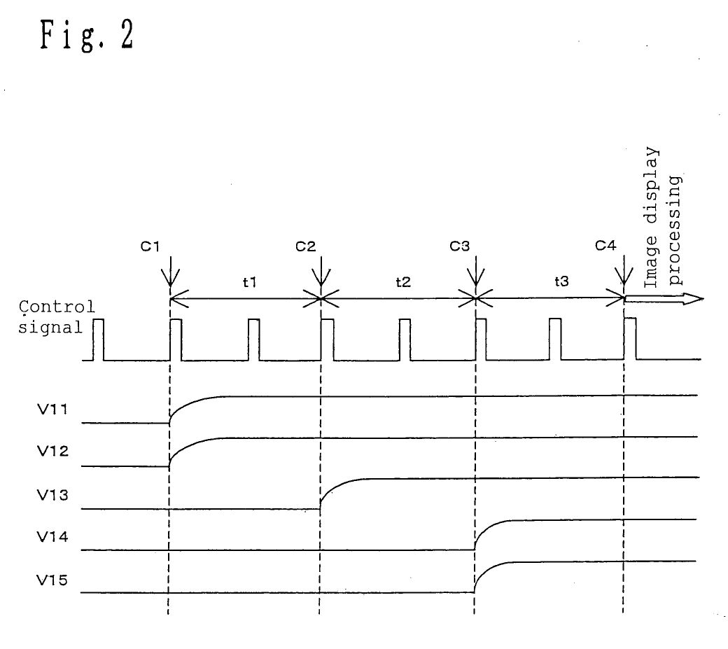

The following will discuss operations on the startup of the liquid crystal display device according to the present embodiment mainly with reference to FIG. 1 which is an explanatory drawing for explaining a voltage rising sequence from when voltage generation is started on startup to when the subsequent image display is started, and FIG. 2 which is an explanatory drawing for explaining the timing of generating liquid crystal driving voltages V11 to V15 on the startup by the liquid crystal driving voltage generating circuit 540 according to Embodiment 1 of the present invention.

Besides, the following will also discuss an embodiment of a method of generating voltage while discussing operations on the startup of the liquid crystal display device of the present embodiment.

FIGS. 1 and 2 show the case of V11=V12>V13>V14=V15. In the present embodiment, the driving voltages of circuits are raised in decreasing order of voltage values. As a matter of course, the order of the voltage rise sequence and the order of voltage values may not agree with each other.

Further, in FIGS. 1 and 2, reference numeral C1 denotes count timing of starting the generation of V11 and V12, reference numeral C2 denotes count timing of starting the generation of V13, reference numeral C3 denotes count timing of starting the generation of V14 and V15, reference numeral C4 denotes count timing of starting image display, reference numeral t1 denotes a time interval between C1 and C2, reference numeral t2 denotes a time interval between C2 and C3, and reference numeral t3 denotes a time interval between C3 and C4.

Each of the time intervals t1 to t3 is an integral multiple of a control signal period. Further, the number of counts of a control signal between C1 and C2, between C2 and C3, and between C3 and C4 can be set by the liquid crystal driving voltage generating circuit 4 so that t1 to t3 approximate time periods required for the conventional wait processing W1 to W3. V11 to V15 correspond to V31 to V35 of the conventional art in this order.

As described above, the control signal sent from the controller circuit 530 to the liquid crystal driving voltage generating 540 is a control signal having a fixed period. Counting is performed in the counter circuit 541 of the liquid crystal driving voltage generating circuit 540 according to the period.

To be specific, the generation of V11 and V12 is started in the liquid crystal driving voltage generating circuit 540 concurrently with the counting of C1.

When the generation of V11 and V12 is started and the counting reaches C2, the generation of V13 is started in the liquid crystal driving voltage generating circuit 540.

At C3, the generation of V14 and V15 is started in the liquid crystal driving voltage generating circuit 540.

At C4, an image display processing setting is transferred from the CPU 520 via the controller circuit 530 to start processing of image display.

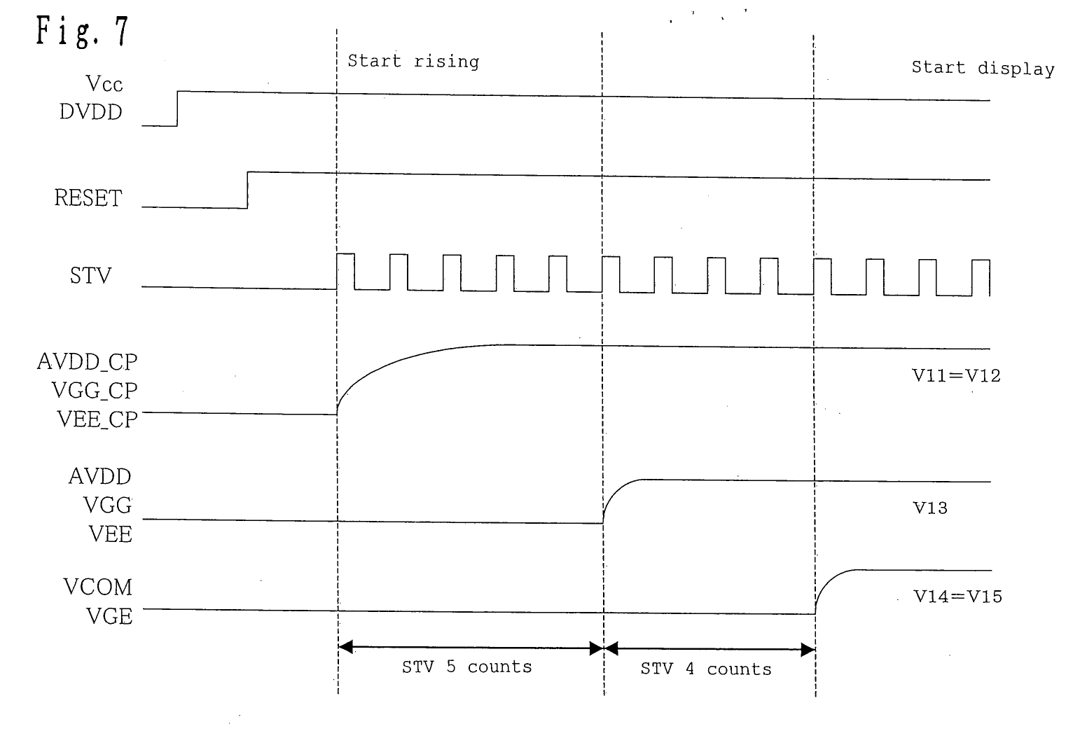

Besides, as shown in FIG. 7 which is a detailed explanatory drawing for explaining the timing of generating liquid crystal driving voltage on the startup by the liquid crystal driving voltage generating circuit 540 according to Embodiment 1 of the present invention, the specific example of V11=V12 includes AVDD_CP (AVDD, VCOM, VGE operational amplifier power supply), VGG_CP (VGG operational amplifier power supply), and VEE_CP (VEE operational amplifier power supply). The specific example of V13 includes AVDD (analog supply voltage for a source driver), VGG (on voltage for a switching device) and VEE (off voltage for a switching device). The specific example of V14=V15 includes VCOM (common potential) and VGE (gate compensating supply voltage).

Moreover, the number of counts of the control signal is 5 between C1 and C2 in the specific example, and the number of counts of the control signal is 4 between C2 and C3 in the specific example (FIGS. 2 and 7).

The above explanation described the detail of Embodiment 1.

(A) Further, the display panel of the present invention is the liquid crystal display panel 570 in the present embodiment. The display panel is not particularly limited and the display panel of the present invention may be a display panel of other matrix systems such as an EL (electroluminescence) display panel.

(B) Moreover, the voltage generating/outputting means is the voltage generating/outputting circuit 543 in the present embodiment. The voltage generating/outputting means of the present invention is not particularly limited and any means is applicable as long as a plurality of kinds of voltages having predetermined voltage values are generated and outputted.

(C) Besides, the counter means of the present invention is the counter circuit 541 in the present embodiment. The counter means of the present invention is not particularly limited. To put it briefly, any means is applicable as long as counting is performed according to a control signal outputted with a predetermined period from the outside.

Additionally, the counter means of the present invention is provided in the liquid crystal driving voltage generating circuit (DC-DC) 540 in the present embodiment. The configuration is not particularly limited and thus the counter means may be provided in the controller circuit 630 or the CPU (central processing unit) 620.

Further, the control signal of the present invention is the control signal of a frame period (so-called frame control signal) in the present embodiment. The control signal of the present invention is not particularly limited. To put it briefly, any control signal is applicable as long as a predetermined period can be controlled in a similar manner.

(D) Moreover, the voltage generation timing managing means of the present invention is the voltage generation timing managing circuit 542 in the present embodiment. The voltage generation timing managing means of the present invention is not particularly limited. To put it briefly, any means is applicable as long as the timing of generating voltage is managed according to performed counting (count control).

(E) Besides, the program of the present invention is a program which causes a computer to perform operations of all or some of the steps (or processes, operations, actions, etc.) of the method of generating voltage according to the present invention, and the program operates in cooperation with the computer.

Additionally, the recording medium of the present invention is a recording medium which bears a program of causing the computer to perform all or some of the operations of all or some of the steps of the method of generating voltage according to the present invention. The recording medium can be read by the computer and the read program performs the operations in cooperation with the computer.

Further, “some of the steps (or processes, operations, actions, etc.)” of the present invention indicate one or some of the plurality of steps.

Moreover, “operations of the steps (or processes, operations, actions, etc.)” indicate the operations of all or some of the steps.

Further, the program of the present invention may have a utilization mode in which the program is recorded on a recording medium readable by the computer and operates in cooperation with the computer.

Besides, the program of the present invention may have a utilization mode in which the program is transmitted through a transmission medium, is read by the computer, and operates in cooperation with the computer.

Moreover, the recording medium includes a ROM and the transmission medium includes light, a radio wave, a sound wave and a transmission medium such as the Internet.

Besides, the computer of the present invention is not limited to pure hardware such as a CPU. The computer may include firmware, an OS, and peripheral equipment.

As described above, the configuration of the present invention may be realized as software or hardware.

In this way, counting is performed for each predetermined period in the liquid crystal driving voltage generation circuit and wait processing is artificially performed in a time period, which is an integral multiple of a control signal period, until voltage is stabilized, so that the CPU does not have to monitor wait processing all the time when voltage is generated. Therefore, the working efficiency of the CPU is greatly increased, high-speed processing is enabled, and other processing such as the start of image display on the liquid crystal display panel can be performed concurrently with voltage generation.

As a matter of course, the voltage generating circuit of the present invention is different from a circuit (e.g., Japanese Patent Laid-Open No. 2002-207458) in which a display control circuit has detectability of an abnormal clock, a clock signal supplied from the outside is counted in an internal counter circuit, (1) power supply is stopped when the number of counts is 0, and (2) display data is fixed at white or black and is transmitted when the number of counts is an abnormal value other than 0.

The entire disclosure of Japanese Patent Laid-Open No. 2002-207458 is incorporated herein by reference in its entirety.

### Industrial Applicability

As is evident from the above description, the present invention has an advantage that the working efficiency of the CPU on the startup of the liquid crystal display device is greatly increased.

1. A voltage generating circuit, comprising:
voltage generating/outputting means which generates two or more kinds of voltages, each having a predetermined voltage value, and outputs the generated voltages,
counter means of performing counting according to a control signal inputted with a predetermined period from an outside, and
voltage generation timing managing means of managing timing of generating the voltages according to the performed counting.

2. The voltage generating circuit according to claim 1, wherein the two or more kinds of voltages are driving voltages of driving a plurality of circuits in a display device, the driving voltages being determined for the respective circuits.

3. The voltage generating circuit according to claim 2, wherein the control signal inputted from the outside is a control signal which is inputted from a controller circuit to control the plurality of circuits in the display device.

4. The voltage generating circuit according to claim 2, wherein the predetermined period is a frame period used for display provided in the display device.

5. A display device, comprising:
the voltage generating circuit according to claim 1,
a display panel having a plurality of pixels arranged so as to correspond to intersections of source lines in two or more columns and gate lines in two or more rows,
a source driver of driving the source lines in the two or more columns by using source line driving voltage required for driving the source lines in the two or more columns, and
a gate driver of driving the gate lines in the two or more rows by using gate line driving voltage required for driving the gate lines in the two or more rows.

6. A method of generating voltage, comprising:
generating two or more kinds of voltages, each having a predetermined voltage value, and outputting the generated voltages,
performing counting according to a control signal inputted with a predetermined period from the outside, and
managing timing of generating the voltages according to the performed counting.

7. A program of causing a computer to perform counting according to a control signal inputted with a predetermined period from the outside, and managing timing of generating the voltages according to the performed counting, in accordance with the method of generating voltage according to claim 6.

8. A recording medium bearing the program according to claim 7 and which recording medium is configured to be processed by the computer.
